(19) United States
(12) Patent Application Publication
(10) Pub. No.: US 2016/0379723 A1
(43) Pub. Date: Dec. 29, 2016

(54) SYSTEM FOR PURIFYING A GASEOUS MEDIUM OF HYDROGEN AND METHOD FOR THE USE THEREOF

(71) Applicant: JOINT STOCK COMPANY "AKME-ENGINEERING", Moscow (RU)

(72) Inventors: Petr Nikiforovich Martynov, OBNINSK (RU); Radomir Shamilievich Askhadullin, OBNINSK (RU); KONSTANTIN DMITRIEVICH IVANOV, OBNINSK (RU); SAID-ALI SABIROVICH NIYAZOV, OBNINSK (RU)

(21) Appl. No.: 15/021,692

(22) PCT Filed: Nov. 21, 2014
(86) PCT No.: PCT/RU2014/000883

§ 371 Date: Mar. 12, 2016

(30) Foreign Application Priority Data
Nov. 26, 2013 (RU) 2013152258
Dec. 10, 2013 (RU) 2013154534

(51) Int. Cl. G21C 9/06; F23Q 11/00

(52) U.S. Cl. CPC G21C 9/06; F23Q 11/00; G21Y 2002/104; G21Y 2004/30

(57) ABSTRACT

Disclosed is a hydrogen igniter for igniting hydrogen contained in a gaseous medium, said hydrogen igniter comprising a housing with openings for the supply and discharge of a gaseous medium, and a filler in the form of bismuth oxide and/or lead oxide, disposed inside the housing. Also disclosed are a system for purifying a gaseous medium of hydrogen having such a hydrogen igniter, and a method for the repeated use of such a system. The igniter and the system can be used in a nuclear reactor facility.

### FIELD OF THE INVENTION

The present invention relates to systems and apparatus for purifying a gaseous medium from hydrogen, in particular, to the hydrogen igniter.

### BACKGROUND ART

One of the issues of provision of safe operation of a nuclear reactor is to remove gaseous hydrogen from the nuclear reactor gas circuits as accumulation of gaseous hydrogen may lead to a hazardous concentration of gaseous hydrogen in a gas circuit, which may cause an adverse interaction of hydrogen with structural materials resulting in degradation of such materials (mainly of the protective oxide film on the circuit component outer surface). In addition, accumulation of hydrogen in the gas circuits preconditions accumulation of an explosive concentration of gaseous hydrogen.

To remove gaseous hydrogen from a gas circuit, various means can be used. Patent RU2430876 discloses an apparatus for hydrogen removal from a hydrogen-containing gaseous mixture. Operation of the disclosed apparatus is based on hydrogen diffusion through a permeable diaphragm. As a result, pure hydrogen is collected in the cavity behind the diaphragm, and the remaining medium with a reduced content of hydrogen is supplied to the outlet nozzle. This is a low-efficiency scheme, when gaseous hydrogen is required to be removed from a gas mixture with low hydrogen content, as a long period of time is required for hydrogen diffusion through the diaphragm and a large-area permeable diaphragm.

An apparatus for removal of gaseous hydrogen from a hydrogen-containing gas mixture is known described in Patent U.S. Pat. No. 6,356,613. In the known apparatus, a gas mixture containing gaseous hydrogen passes through a catalytic bed in which low-temperature oxidation of gaseous hydrogen to water occurs, and the processed gas mixture is removed from the apparatus. Hydrogen oxidation to water (water vapor) permits quick and effective removal of hydrogen from gas circuits, as the oxidized hydrogen (water, water vapor) can be easily removed from a gas circuit by application of a well-proven gaseous medium drying technology.

However, this apparatus may be applied only in a gas medium containing oxygen. When processing an anoxic gaseous medium, the apparatus is not capable of purifying such hydrogen-containing anoxic gaseous medium from gaseous hydrogen.

Anoxic gaseous media are used in liquid-metal coolant reactor gas circuits, and effective means are required for removal of hydrogen and similar gases from the anoxic gaseous medium of the gas circuits.

To maintain the required impurity composition of the protective gas (gaseous medium), typically an inert gas, removal of hydrogen from the protective gas is also required during operation of nuclear reactor plants. Protective gas can be purified of hydrogen using a hydrogen igniter.

Patent RU2253915 discloses a hydrogen igniter containing lead oxide and capable of carrying flows of hydrogen-containing inert gas (gaseous medium). Hydrogen with lead oxide is oxidized to water entrained by flowing inert gas.

When purifying a gaseous medium (protective gas) of hydrogen using the said igniter, protective gas may be contaminated with lead or lead oxide impurities. Such impurities may have an adverse effect on structural components of the reactor facility, as well as on the coolant, for example, by contaminating it.

Since water resulting from oxidation of hydrogen on lead oxide is not removed from the flowing gaseous medium, the output protective gaseous medium is saturated with water vapor with the concentration that may exceed the acceptable level.

In addition, as the afterburning of hydrogen occurs in the course of the reaction of reduction of copper oxide to copper, then after all or useful copper oxide is reduced to copper during operation of the hydrogen igniter, it will be required to remove such copper from the igniter and place a new portion of copper oxide in it.

Moreover, it shall be noted that efficiency of the hydrogen igniter on lead oxides is relatively low.

### INVENTION DISCLOSURE

The object of the invention is to produce a hydrogen igniter that would not contaminate gaseous medium (e.g. protective gas) with impurities harmful for structural components of the reactor facility and/or the coolant, in particular, the lead-bismuth coolant. Another object of this present invention is to improve efficiency of the hydrogen igniter. A further object of the invention is to remove water vapor resulting from hydrogen ignition from the gaseous medium transmitted through the hydrogen igniter in compliance with this invention.

In addition, the purpose of this invention is to provide a system for purifying a gaseous medium from hydrogen by afterburning that will not contaminate the gas medium (for instance, the protective gas) by impurities having an adverse impact on the reactor plant structural components and/or coolant, in particular, lead-bismuth coolant. Another purpose of this invention consists in provision of long-term operation of the system without need for replacement/replenishment of a substance used for hydrogen afterburning.

Solution for this object of the invention is a hydrogen igniter for igniting hydrogen contained in a gaseous medium and comprising a housing with openings for the supply and discharge of a gaseous medium, and a filler containing bismuth oxide and/or lead oxide, disposed inside the housing. One of the embodiments, bismuth oxide appears as Bi₂O₃, and the preferred filler is granular.

At least one reaction vessel with a filler can be installed on the igniter housing. The preferred embodiment housing disposes a distribution pipe passing from the gaseous medium supply opening through at least one reaction vessel, provided that the side walls of such distribution pipe have openings at the penetrations through reaction vessels. In addition, at least one reaction vessel shall preferably have openings for the supply and discharge of a gaseous medium.

The igniter housing may be equipped with a heater. The preferred embodiment housing has a cover with an opening for the supply of a gaseous medium, a bottom with an opening for the gaseous medium removal is in the bottom, and the heater is installed on the side wall of the housing.

The task of this invention is also solved using a system for purifying a gaseous medium from hydrogen comprising any of the above hydrogen igniter embodiments, a supply pipeline connected to the igniter housing, with possible supply of a gas medium to the gaseous medium supply orifice, an outgoing pipeline connected to the hydrogen igniter housing, with possible removal of a gas medium from the gas medium removal orifice, shutoff valves installed on the supply pipeline providing control of the hydrogen-containing gas medium supply, and shutoff valves installed on the outgoing pipeline providing control of the oxygen-containing gas medium supply.

The supply pipeline may be equipped with a heater. The gaseous medium flowing through the igniter mostly includes inert gas.

In the preferred embodiment, the system also comprises a chiller and a condenser, wherein the hydrogen igniter housing and the chiller are interconnected by means of the outgoing pipeline, with possible removal of a gas medium from the gaseous medium removal orifice to the chiller and condenser.

The system may comprise shutoff valves installed on the outgoing pipeline providing control of gaseous medium removal.

As a solution for this invention, a reactor plant comprising any of the above hydrogen igniter embodiments or a system for purifying a gaseous medium from hydrogen in any of the above embodiments is provided. The preferred embodiment of the reactor facility is a nuclear one and it preferably uses lead-bismuth coolant.

As a solution for this invention, a method of repeated operation of the system for purifying a gaseous medium from hydrogen having a hydrogen igniter consisting of a housing with orifices for supply and removal of a gaseous medium, and an oxygen-containing filler placed in the housing, a supply pipeline connected to the hydrogen igniter housing, with possible supply of a gas medium to the gaseous medium supply orifice, an outgoing pipeline connected to the hydrogen igniter housing, with possible removal of a gas medium from the gas medium removal orifice, shutoff valves installed on the supply pipeline providing control of the hydrogen-containing gas medium supply, and shutoff valves installed on the outgoing pipeline providing control of the oxygen-containing gas medium supply is provided.

The method comprises the following steps: a hydrogen-containing gaseous medium is supplied to the hydrogen igniter; the supply of the hydrogen-containing gaseous medium to the hydrogen igniter is stopped; an oxygen-containing gaseous medium is supplied to the hydrogen igniter; the supply of the oxygen-containing gaseous medium to the hydrogen igniter is stopped. When the hydrogen-containing gaseous medium is supplied to the hydrogen igniter, the gaseous medium may be removed from the hydrogen igniter. When the oxygen-containing gaseous medium is supplied to the hydrogen igniter, the supplied oxygen-containing gaseous medium may be kept in the hydrogen igniter, and after the oxidation of bismuth and/or bismuth oxide is completed, the oxygen-containing gaseous medium may be removed.

In the preferred embodiment, the oxygen-containing filler contains a metal oxide. Such metal oxide may appear as bismuth oxide BiO and/or Bi₂O₃ and/or lead oxide. Preferably, the oxygen-containing filler is granular.

Preferably, at least one reaction vessel with an oxygen-containing filler is placed in the igniter housing. In addition, a distribution pipe can also be installed in the housing passing from the gaseous medium supply orifice through at least one reaction vessel, wherein the distribution pipe can have openings in the side walls at the points of penetration through reaction vessels. At least one reaction vessel can also have orifices for supply and removal of the gaseous medium.

The housing may be equipped with a heater. The preferred embodiment housing has a cover with an opening for the supply of a gaseous medium, a bottom with an opening for the discharge of a gaseous medium, and a side wall with a heater installed on it. The supply pipeline may be equipped with a heater. In the preferred embodiment, the gaseous medium contains an inert gas.

Additionally, the system may comprise a chiller and a condenser, wherein the hydrogen igniter housing and chiller can be interconnected by means of the outgoing pipeline, with possible removal of a gas medium from the gaseous medium removal orifice to the chiller and condenser.

In the preferred embodiment, the system has shutoff valves installed on the outgoing pipeline providing control of gaseous medium removal.

The result of this invention is a hydrogen igniter and a system for purifying a gaseous medium that ensure such technical result as zero contamination of the gaseous medium with impurities harmful for structural components of the reactor facility and/or the coolant, in particular, the lead-bismuth coolant. This allows to enhance reliability of the reactor design using such a hydrogen igniter and/or gas purification system, as well as the operation safety of such a reactor.

In addition, this invention yields such technical result as increased efficiency of the hydrogen igniter, which allows to reduce the weight and dimensions of the hydrogen igniter and the equipment comprising the same, and decrease their cost.

Also, this invention provides a technical result consisting in increased duration of operation of the gaseous medium purification system with no need for replacement/replenishment of a substance used for hydrogen burning, which reduces consumption of the substance used for hydrogen afterburning, and eliminates operations of its replacement/replenishment, which generally reduces operating costs, both labor costs and financial expenses.

This invention also provided for such technical result as removal of water vapor resulting from hydrogen ignition from the gaseous medium transmitted through the hydrogen igniter in compliance with this invention. This allows to improve operational reliability of the devices using gaseous medium, as well as to improve service life of the gaseous medium itself, thus reducing the labor costs for its replacement and improving financial indicators due to the reduction of explicit costs for the gaseous medium replaced.

### BRIEF DESCRIPTION OF THE DRAWINGS

FIG. 1 shows the hydrogen igniter in accordance with this invention with pipelines for the supply and discharge of a gaseous medium and equipment for gaseous medium supply and discharge control.

### IMPLEMENTATION OF THE INVENTION

This invention discloses a hydrogen igniter for igniting hydrogen contained in a gaseous medium, designed preferably using inert gases, such as helium, neon, argon, krypton, xenon and/or radon. Use of inert gas as the main component of the gaseous medium helps to improve efficiency of the igniter operation and reduce the cost of the filler consumption as the igniter will only burn up impurities (including hydrogen) and will not interact with the inert gas due to inert chemical properties of such gases. Use of inert gas also helps to reduce the effect on structural components of the igniter, such as the housing, etc., thus increasing its useful life and reducing maintenance costs.

The hydrogen igniter is comprised of a housing with openings for the supply and discharge of a gaseous medium, and a filler containing bismuth oxide and/or lead oxide, disposed inside the housing. If bismuth and/or lead in the housing is not in the form of an oxide, but, for example, a metal, such embodiment may also be considered to be one of the embodiments of this invention, as bismuth oxide may be easily obtained from metal bismuth, and lead oxide can be obtained from lead by feeding it through the igniter of oxygen or oxygen-containing gaseous medium. Due to application of a metal, the filler may remain in the concentrated form and not evaporate into the gaseous medium. Different metals ensuring the redox reaction under the set conditions may be used as the metal forming part of metal oxide, for instance, copper. However, if the hydrogen igniter is used as part of a nuclear reactor plant with a lead-bismuth filler, it is preferable to use bismuth or lead as the metal (i.e oxides Bi₂O₃, BiO or PbO).

The igniter housing disposes a filler, that is a bismuth oxide and/or lead oxide according to the invention. As bismuth and lead are heavier metals compared to copper, contamination of the gaseous medium passing through bismuth oxide and/or lead oxide may be reduced, as heavier atoms and their compounds are less likely to be carried away by the gaseous medium. In addition, if the igniter is used in the system for purifying a gaseous medium from hydrogen applied, for instance, in a nuclear reactor with a lead-bismuth coolant, bismuth or lead in a gaseous medium used, for instance, as a cover gas will not be considered coolant contamination. Moreover, the coolant passing through the gaseous medium will not contaminate the igniter filler. All of this allows to increase the service life both of the coolant and the filler of the igniter.

The principle of operation of the igniter is mainly based on the chemical reaction of partial reduction of bismuth oxide Bi₂O₃ to BiO with water vapor formation:

Bi₂O₃+H₂→2BiO+H₂O.

Use of bismuth oxide instead of lead oxide improves efficiency of the ignition, but the reaction of partial reduction of bismuth oxide allows to additionally improve efficiency of the ignition. Correspondingly, it is preferable that the igniter is filled with bismuth oxide Bi₂O₃ and not bismuth oxide BiO, as the presence of the former allows partial reduction reaction, and the latter ensures the complete reduction reaction with formation of bismuth in the metal form.

To be able to use the hydrogen igniter without replacement of the reacted filler, it may be oxidized by igniter oxygen makeup by reaction

2BiO+0,5O₂→Bi₂O₃.

This provides practical process reversability and, therefore, a long igniter service life without replacement of the oxide filler. If pure bismuth Bi is produced, then the reaction with oxygen will first produce BiO and then Bi₂O₃.

According to this invention, the system for purifying a gaseous medium from hydrogen is mainly operated repeatedly, with the following cycling:
a hydrogen-containing gaseous medium is supplied to the igniter (it is preferable to remove the gaseous medium that reacted with the filler and contains water vapor from the hydrogen igniter, this allows to supply a gaseous medium on a long-term or continuous basis, thus increasing afterburning efficiency and rate as compared to the mode of alternating supply and removal of the gaseous medium with hydrogen);
the supply of the hydrogen-containing gaseous medium to the hydrogen igniter is stopped, this may occur, for instance, when hydrogen afterburning efficiency reduction is identified or by a schedule of works for igniter conditioning;
for the filler conditioning, i.e. filler oxidation, an oxygen-containing gaseous medium is supplied to the hydrogen igniter;
supply of the oxygen-containing gaseous medium to the hydrogen igniter is stopped.

In the preferred embodiment, the supplied oxygen-containing gaseous medium is kept in the igniter, i. e. not removed, which allows to reduce the oxygen-containing gaseous medium consumption, improve its efficiency and reduce or prevent an impact of oxygen on the equipment downstream the shutoff valves (9), for instance, a chiller and/or condenser. After the oxidation of the filler in the form of bismuth and/or bismuth oxide, the oxygen-containing gaseous medium is mainly removed, this allows to reduce the risk of direct reaction of the oxygen residue in the gaseous medium with hydrogen in the newly supplied gaseous medium that may be explosive.

The above cycle operations may be repeated a considerable number of times, which allows using one and the same filler repeatedly, thus increasing the igniter service life due to elimination of assembly/disassembly operations, and reducing labor and financial costs of filler replacement.

Application of such cycle also facilitates a more effective reaction of partial reduction in the igniter, as described above, as when the concentration of bismuth oxide BiO in the filler reaches a set value, the oxidation to the initial oxide Bi₂O₃ may be performed, preventing the operation of complete reduction of the oxide BiO to bismuth in form of the Bi metal.

Application of a granular filler (for instance, balls) is aimed at maintaining the reduction reaction in the partial form, thus ensuring higher efficiency. This allows to prevent filler sintering, thus increasing the filler service life. Granular filler form ensures easy fabrication and handling of the filler at the stages of placement into and removal from the igniter housing, which reduces labor requirements and cost of the igniter in general, improves serviceability of the igniter. In addition, application of a granular filler ensures a larger area of reaction of bismuth oxide and hydrogen (oxygen) and, therefore, higher efficiency of the process as such granular filler has gaps between grains the gaseous medium can flow through: when the grains are spherical, such gaps will have the largest guaranteed size.

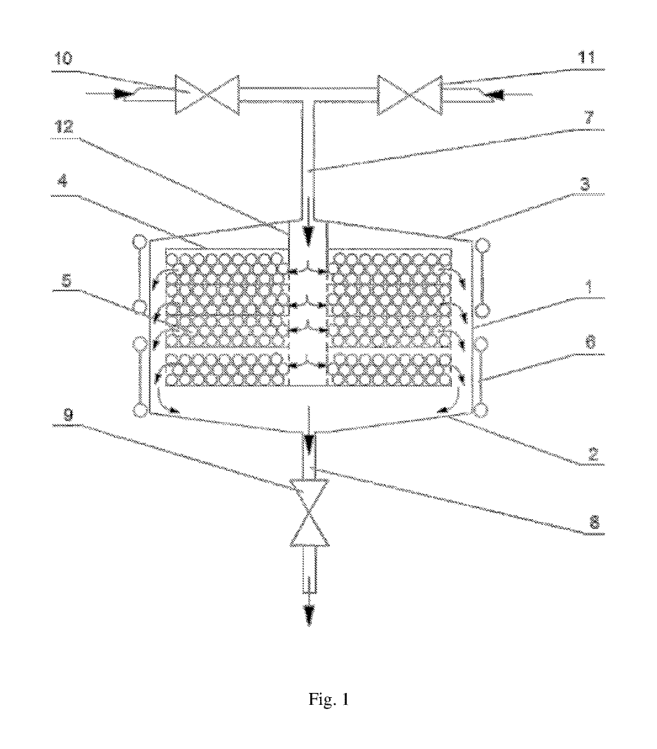

FIG. 1 shows the preferred embodiment of the system for purifying a gaseous medium from hydrogen according to this invention comprising a hydrogen igniter with pipelines for gaseous medium supply and removal and valves for gaseous medium supply and removal control.

The hydrogen igniter housing shown in FIG. 1 consists of one side wall (1), bottom (2) and lid (3). The housing of the igniter embodiment shown in FIG. 1 is specially designed for execution of its functions as an item, however, the igniter housing can be presented by housing components of other devices, for example, when installing the filler between the housings of the devices forming part of the system for gaseous medium purification of hydrogen or the reactor facility.

The igniter housing can be made of metal, composite or polymer materials ensuring sufficient mechanical strength, thermal stability, resistance to chemicals of the gaseous medium and filler (bismuth oxide) and lack or insignificance of emissions that may contaminate the gaseous medium. The preferred embodiment housing is made using steel. The housing design is leak-tight for the most part so that the gaseous medium supplied through the supply opening is discharged only from the gaseous medium discharge opening. In this case, interaction of the gaseous medium and the filler is more complete and hydrogen ignition is more efficient, as well as leaks into the environment are prevented ensuring igniter operation safety improvement and reduction of the environmental contamination.

The cover (3) has an opening for the supply of the gaseous medium, the said opening is used to supply gaseous medium into the igniter from supply pipelines (7) connected to the housing of the hydrogen igniter and enabling gaseous medium supply into the opening for the supply of the gaseous medium for implementation of the ignition process. The bottom (2) has an opening for discharge of the gaseous medium, the said opening is used to discharge gaseous medium from the igniter discharge pipeline (8) connected to the hydrogen igniter housing and enabling gaseous medium discharge from the gaseous medium discharge opening for implementation of the ignition process in the flowing gaseous medium.

Openings shown in FIG. 1 are made in the cover and bottom of the housing and have relatively small cross section area, but the opening size of other embodiments may be significantly greater to the extent that the igniter is not equipped with a cover and bottom and gaseous medium is supplied and discharged through the entire cross section of the housing. This housing embodiment is also included in the scope of protection of this invention. Certain embodiments may not have a discharge opening, but in this case the efficiency of igniter operation will be reduced as discharge openings provide for a more efficient operation of the igniter with the flowing gaseous medium. Other embodiments may have discharge openings located near the supply opening or several parts of the same opening may be used for the gaseous medium supply and discharge; such openings are also included in the scope of protection of this invention.

Supply and discharge pipelines may be welded to the housing or connected by any other known state-of-art method providing for sufficient mechanical strength, thermal stability and resistance to chemicals as well as soft gaseous medium or filler. A sufficiently leak-tight connection of the pipelines to the housing allows to supply a gaseous medium to the igniter without losses. The pipelines, partially or entirely, may be integrated with the igniter housing at the housing manufacture stage, for instance, as pipe sections from the orifices for pipeline connection. These embodiments allow for facilitation of the igniter attachment to pipelines and are included in the scope of protection of this invention.

As shown in FIG. 1, in the preferred embodiment, shutoff valves (10) for hydrogen-containing gaseous medium supply control and shutoff valves (11) for oxygen-containing gaseous medium supply control are installed on the outgoing pipeline (7). Shutoff valves (9) may be installed on the outgoing pipeline 8 for gaseous medium removal control. Shutoff valves (9-11) may be designed, for instance, as gas check valves and may be used for implementation of the above method of hydrogen igniter cycling. The supply pipeline may include a T-piece (manifold) the hydrogen-containing gaseous medium supply pipeline and oxygen-containing gaseous medium supply pipeline are connected to (they may also be considered entering the supply pipeline). Shutoff valves (10) and (11) may be installed on the hydrogen-containing gaseous medium supply pipeline and oxygen-containing gaseous medium supply pipeline, respectively.

To supply the hydrogen-containing gaseous medium, valve (10) must be open, and for implementation of the passing mode of the gaseous medium flow, valve (9) must also be open. To stop the hydrogen-containing gaseous medium supply, valve (10) is closed. Removal of the gaseous medium through the outgoing pipeline may be stopped when or after the gaseous medium supply through valve (10) is stopped by closing shutoff valve (9). The oxygen-containing gaseous medium is preferably supplied and removed through shutoff valve (11) that must be open for this purpose. Shutoff valve (9) is closed at that time, however, it is possible for filler to be oxidized with the passing oxygen-containing gaseous medium flow, for which purpose valve (9) must be opened. After supply of the oxygen-containing gaseous medium or its removal is stopped, valve (11) may be closed.

Oxygen-containing filler (5) may include oxygen compounds, for instance, acids, oxides, peroxides, ozonides, etc. preferably in a solid or liquid form. In the preferable embodiment, the oxygen-containing filler is a metal oxide as in such form the oxygen-containing material is mainly solid and when oxygen is consumed for hydrogen afterburning (reduction of the oxide metal), the reaction result is also mainly solid, but not gas or liquid, which allows to keep the filler in the housing without extra measures for subsequent saturation of the filler with oxygen (in case of a metal oxide, metal oxidation). In addition, the solid filler simplifies its handling, as in this case it may be in the form of grains that may be easily transferred, kept and allow gaseous medium to pass through. At the same time, the oxygen-containing filler may be in the liquid form; in this case extra measures will be required to ensure the reaction between the gaseous medium and the filler, for instance, passing the gaseous medium through the oxygen-containing filler.

The filler (5) in a form of bismuth oxide may be located inside the housing of the hydrogen igniter, for example, at the bottom (2), however, the preferred embodiment of this invention distributes bismuth oxide (5), for example, in a granular form, in one or more reaction vessels (baskets) (4). This allows to improve the easy of manufacturing and maintenance of the igniter, as filler (5) may be first placed in reaction vessels (4), and then containers (4) may be placed in the igniter housing, which eliminates a more complex operation of filler placement immediately in the igniter housing. In addition, reaction vessels allow to improve the utilization efficiency of the housing by implementation of several levels of filler (15) distribution.

As shown in FIG. 1, the housing of the preferred igniter embodiment disposes a distribution pipe (12) passing from the gaseous medium supply opening in the cover (3) through at least one reaction vessel (4). The distribution pipe may supply the gaseous medium to the reaction vessel placed after the container it passes through for supply, for instance, from the tube end, however, in the preferred embodiment, the distribution pipe has openings in the side walls at the points of penetration through the reaction vessels, which allows to improve efficiency of gaseous medium supply by its distribution among all reaction vessels.

When several reaction vessel levels are available, as shown in FIG. 1, the distribution pipe may have an open orifice, through which the gaseous medium is supplied directly to the lower reaction vessel and reaches the bottom of the lower reaction vessel where it may be plugged by the container bottom or a special plug, and in that case the gaseous medium may be supplied to the lower reaction vessel through the side orifices in the distribution pipe. Due to the that a more complete flow of the gaseous medium through the reaction vessels and filler is provided, resulting in improved efficiency of the hydrogen igniter as the gaseous medium cannot be supplied to the gaseous medium removal orifice without reacting with the filler.

Reaction vessels (4) have openings for the supply and discharge of a gaseous medium. If the vessels (4) are arranged in several layers, for example, in the center, a distribution pipe (12) passes through these layers, as shown in FIG. 1, the gaseous medium flow through the filler will be more efficient. The said filler will be located between the bottom vessel components (filler in the upper vessel will be located between the vessel bottom and the igniter cover) and will pass through side walls of the vessels, for example, at the periphery of vessels (4) to the housing walls (1), and then will flow down to the opening for the gaseous medium discharge at the bottom (2), as shown in FIG. 1. The igniter structure shown in FIG. 1 is optimized from the viewpoint of arrangement of the gaseous medium flow for improved efficiency of hydrogen afterburning on the filler and provision of the maximum possible uniformity of transformation of the initial metal supply, and, in case bismuth is used as the metal in the oxide, the structure of the igniter allows to reduce or eliminate the transformation of BiO to metallic Bi, maintaining the reaction within partial reduction of Bi₂O₃ to BiO.

In addition, hydrogen ignition efficiency may be improved by increasing temperature of the gaseous medium and/or filler and/or reaction vessels and/or the housing up to 500° C. This can be done by installing a heater (6) comprising one or more sections, as shown in FIG. 1, on the housing, for example, on its side wall (1). The heater can be of an electric or other form. The heated housing will heat the gaseous medium and the filler will be heated by the heated gaseous medium and/or through the distribution pipe and reaction vessels.

In some cases it may be useful to install a heater on the supply pipeline to preheat the gaseous medium supplied into the igniter housing. This will allow to feed gaseous medium that has already been heated and to eliminate the need to heat gas inside the housing whereby hydrogen ignition may start immediately upon gaseous medium supply into the housing to the filler, thus improving igniter efficiency.

Hydrogen ignition results in water vapor formation that is removed from the igniter as part of the gaseous medium. In certain cases water vapor may be treated as undesirable impurities and gaseous medium will require purification. For this purpose, in addition to the hydrogen igniter, the system for purifying a gaseous medium from hydrogen may comprise a chiller, condenser and an outgoing pipeline connected to the hydrogen igniter housing and the chiller, with possible removal of the gaseous medium from the gaseous medium removal orifice to the chiller and condenser. Gaseous medium is cooled down in the cooler and water vapor is condensed in the condenser; the gaseous medium is freely flowing from the coolant and the condenser and may be re-used for its intended purposes in a purified form. The cooler design may include a condenser or two consequently installed devices interconnected using a pipeline that may be deemed to form part of the discharge pipeline or without the use of a pipeline. In addition to the gaseous medium purification of water vapor, cooler application allows to reduce the gaseous medium temperature, for example, after heating it in the igniter, up to the operating one.

The said hydrogen igniter and system for purifying a gaseous medium from hydrogen with a hydrogen igniter in accordance with this invention may be used to purify gaseous medium of hydrogen, for instance, in a reactor facility that can be a nuclear one and use lead-bismuth coolant. Application of the hydrogen igniter containing bismuth oxide and/or lead oxide as a filler will ensure minimal contamination of the lead-bismuth coolant in such a nuclear reactor facility.

This invention may also be presented as an apparatus for removal of hydrogen from anoxic gaseous media, capable of efficient removal of gaseous hydrogen due to the chemical reaction of hydrogen oxidation to water with its subsequent removal as part of the vapor-gas mixture, without using permeable diaphragms, and with restoration of the properties of the apparatus without its disassembly.

The apparatus for removal of gaseous hydrogen from anoxic gaseous media comprises a leak-tight heated housing, a reaction chamber installed inside the same and filled with a filler made of an oxygen-containing material, a system for supply of a hydrogen-containing gaseous medium to the reaction chamber, a system for removal of the processed gaseous medium from the reaction chamber, a system for reduction of oxidation properties of the oxygen-containing material, and a system for mode switching. Inside the housing, a distribution permeable header may be installed in the form of a distribution pipeline, as well as a reaction chamber encompassing the distribution pipeline.

The reaction chamber has at least one perforated section with oxygen-containing material, and openings are made in the partition separating adjacent perforated sections. Preferably, the reaction chamber has several perforated sections placed above one another that are filled with oxygen-containing material grains, preferably, of bismuth oxide. The reaction chamber is installed in the housing with a clearance in relation to its side wall, lid and/or bottom.

Openings may be provided in the reaction chamber side wall for connection of the perforated sections with the oxygen-containing material to the housing cavity. Perforation sizes will preferably prevent free passing of grains of solid bismuth oxides from the reaction chamber sections.

The system for supply of the processed anoxic gaseous medium containing hydrogen to the reaction chamber includes a supply nozzle with a permeable distribution header connected on one end and a pipeline for supply of the processed anoxic gaseous medium containing hydrogen to the apparatus on the opposite end.

The permeable distribution header is manufactured as a distribution pipeline and a reaction chamber encompassing the distribution pipe.

The distribution pipeline section immersed in the reaction chamber (encompassed by the reaction chamber) has a perforated side wall, i. e. it has openings connecting the distribution pipeline cavity to the inner cavities of the perforated sections with the oxygen-containing material of the reaction chamber. A plug is provided on the bottom end of the distribution pipeline that prevents bypassing of the reaction chamber by the processed gaseous medium. The side wall of the reaction chamber is perforated. Perforations connect the housing cavity to the inner cavity of the reaction chamber sections. The sections are divided by means of partitions that are also perforated. Perforations provide reaction chamber flowage for the gaseous medium.

The inlet nozzle for supply of the processed gaseous medium to the apparatus is connected to the distribution pipeline at the top. The pipeline for supply of a hydrogen-containing anoxic gaseous medium and pipeline for supply of an oxygen-containing gaseous medium may be connected to the inlet nozzle outside the housing.

The system for removal of the processed gaseous medium from the reaction chamber may consist of an outgoing pipeline for removal of the processed gaseous medium connected to the apparatus housing for removal of the reacted gaseous medium from the apparatus, a gaseous medium with water vapor produced in the reaction chamber as a result of interaction of gaseous hydrogen (methane and similar gases) and oxygen in oxygen-containing filler grains.

Operation of the apparatus is controlled by means of shutoff valves and temperature variation of the heated housing, for which purpose an electric heater is installed on the outer surface of the housing.

The apparatus comprises means of operation control including three shutoff valves. One shutoff valve is installed in the hydrogen-containing anoxic gaseous medium supply pipeline. Another shutoff valve is installed in the oxygen-containing gaseous medium supply pipeline. The third shutoff valve is installed in the outgoing pipeline.

In the mode of hydrogen removal from the anoxic gaseous medium, shutoff valve 11 is closed and shutoff valves (10) and (9) are open. The flow of the hydrogen-containing gaseous medium through open shutoff valve (10) from pipeline (7) is supplied to the distribution pipeline and the gas flow is supplied to the reaction chamber sections through perforations in the distribution pipeline wall. In the reaction chamber, the hydrogen-containing gas flow bypasses oxygen-containing material grains, preferably, made of bismuth oxide, where hydrogen reacts with oxygen in the bismuth oxide and is oxidized almost completely producing water vapor. The gaseous medium processed in the reaction chamber is supplied to the gap between the reaction chamber and housing walls through the reaction chamber wall perforations. Then, the processed gaseous medium is removed from the apparatus with water vapor through open shutoff valve (9). Water vapor may be easily removed from the processed gaseous medium by different means used for removal of water vapor from gases.

If the oxygen-containing material in the reaction chamber is found to have lost its activity, its grain oxidation capacity is restored in the reaction chamber sections by means of an oxygen-containing gaseous medium. In the mode of oxidation of the oxygen-containing gaseous medium grains, shutoff valves (10) and (9) are closed and shutoff valve (11) is opened. An oxygen-containing gaseous medium is supplied to the apparatus through the pipeline for removal of hydrogen from anoxic gaseous media, the reaction chamber and housing volume is filled with an oxygen-containing gaseous medium, and the gas mixture is kept in the housing and reaction chamber until oxygen in the same reacts. Oxygen reacts with the grain material, preferably bismuth, and oxidizes the same producing bismuth oxide. After the oxidation capacity of bismuth has been restored, the remaining oxygen-containing gaseous medium is removed, the apparatus is switched to the mode of hydrogen removal from an anoxic gaseous medium, and hydrogen removal is resumed.

It is preferable to use grains of bismuth oxide (Bi₂O₃) the oxygen-containing material.

Application of a filler made of granulated oxygen-containing material allows to remove hydrogen from an anoxic gaseous medium through direct chemical oxidation of gaseous hydrogen on the grain surface, wherein a large area of contact between the gaseous hydrogen and oxygen-containing material is ensured, which ensures fast and effective removal of hydrogen from the gaseous medium, even with no oxygen in the same. The apparatus ensures restoration of oxidation properties of the grains by regular impact of an oxygen-containing gaseous medium on the same. Hydrogen oxidation to water vapor may be controlled by any known means and such control is not considered within the scope of the application.

Use of bismuth oxide grains eliminates contamination of the gaseous medium by foreign elements as bismuth is included in the nuclear reactor liquid-metal coolant

1.-31. (canceled)

32. A hydrogen igniter for igniting hydrogen contained in a gaseous medium, comprising:
a housing with openings for a supply and discharge of the gaseous medium; and
a filler containing bismuth oxide or lead oxide, disposed inside the housing.

33. The igniter according to claim 32, wherein the bismuth oxide has the formula of Bi₂O₃.

34. The igniter according to claim 32, wherein the filler has a granular form.

35. The igniter according to claim 32, further comprising a reaction vessel disposed inside the housing.

36. The igniter according to claim 35, wherein the housing disposes a distribution pipe passing from a gaseous medium supply opening through the reaction vessel, wherein the distribution pipe has openings in side walls at penetrations through the reaction vessel.

37. The igniter according to claim 35, wherein the reaction vessel has openings for the supply and discharge of the gaseous medium.

38. The igniter according to claim 32, wherein the housing is equipped with a heater.

39. The igniter according to claim 38, wherein the housing has a cover with an opening for the supply of the gaseous medium, a bottom with an opening for the discharge of the gaseous medium, and a side wall with a heater installed on it.

40. A system for purifying a gaseous medium from hydrogen, comprising:
a hydrogen igniter for igniting hydrogen contained in a gaseous medium, comprising:
a housing with openings for a supply and discharge of a gaseous medium; and
a filler containing bismuth oxide or lead oxide, disposed inside the housing;
a supply pipeline connected to the igniter housing providing a supply of the gaseous medium to a gaseous medium supply orifice;
an outgoing pipeline connected to the hydrogen igniter housing providing removal of the gaseous medium from a gaseous medium removal orifice;
shutoff valves installed on the supply pipeline providing control of a hydrogen-containing gaseous medium supply; and
shutoff valves installed on the outgoing pipeline providing control of an oxygen-containing gaseous medium supply.

41. The system according to claim 40, wherein the supply pipeline is equipped with a heater.

42. The system according to claim 40, wherein the gaseous medium includes an inert gas.

43. The system according to claim 40, further comprising:
a chiller and a condenser;
wherein the hydrogen igniter housing and chiller are interconnected by the outgoing pipeline so as to provide removal of the gaseous medium from the gaseous medium removal orifice to the chiller and condenser.

44. The system according to claim 40, wherein the shutoff valves are installed on the outgoing pipeline providing control of gaseous medium removal.

45. A reactor plant, comprising:
a system for purifying a gaseous medium from hydrogen, comprising:
a hydrogen igniter for igniting hydrogen contained in a gaseous medium, comprising:
a housing with openings for a supply and discharge of a gaseous medium; and
a filler containing bismuth oxide or lead oxide, disposed inside the housing;
a supply pipeline connected to the igniter housing providing a supply of the gaseous medium to a gaseous medium supply orifice;
an outgoing pipeline connected to the hydrogen igniter housing providing removal of the gaseous medium from a gaseous medium removal orifice;
shutoff valves installed on the supply pipeline providing control of a hydrogen-containing gaseous medium supply; and
shutoff valves installed on the outgoing pipeline providing control of an oxygen-containing gaseous medium supply.

46. The reactor facility according to claim 45, wherein it is a nuclear reactor facility.

47. The reactor facility according to defined in claim 46, wherein the nuclear reactor facility uses lead with bismuth as a coolant.

48. A method of operation of a system for purifying a gaseous medium from hydrogen, comprising a hydrogen igniter including a housing with openings for a gaseous medium supply and removal and an oxygen-containing filler in the housing, a supply pipeline connected to the igniter housing providing a supply of the gaseous medium to a gaseous medium supply orifice, an outgoing pipeline connected to the hydrogen igniter housing providing removal of the gaseous medium from a gaseous medium removal orifice, shutoff valves installed on the supply pipeline providing control of a hydrogen-containing gaseous medium supply, and shutoff valves installed on the outgoing pipeline providing control of an oxygen-containing gaseous medium supply, comprising the steps of:
supplying the hydrogen-containing gaseous medium to the hydrogen igniter;
stopping the supply of the hydrogen-containing gaseous medium to the hydrogen igniter;
supplying the oxygen-containing gaseous medium to the hydrogen igniter; and
stopping the oxygen-containing gaseous medium to the hydrogen igniter.

49. The method according to claim 48, wherein, when the hydrogen-containing gaseous medium is supplied to the hydrogen igniter, the gaseous medium is removed from the hydrogen igniter.

50. The method according to claim 48, wherein, when the oxygen-containing gaseous medium is supplied to the hydrogen igniter, the supplied oxygen-containing gaseous medium is kept in the hydrogen igniter, and after oxidation of bismuth or bismuth oxide is completed, the oxygen-containing gaseous medium is removed.

51. The method according to claim 48, wherein the oxygen-containing filler contains a metal oxide.

52. The method according to claim 51, wherein the metal oxide is bismuth oxide having the formula of BiO or Bi₂O₃, or lead oxide.

53. The method according to claim 48, wherein the oxygen-containing filler is granular.

54. The method according to claim 48, further comprising the step of providing a reaction vessel that is placed inside the housing.

55. The method according to claim 54, wherein the igniter housing disposes a distribution pipe passing from the gaseous medium supply opening through the reaction vessel, wherein the distribution pipe has openings in side walls at penetrations through the reaction vessel.

56. The method according to claim 54, wherein the reaction vessel has openings for the supply and discharge of the gaseous medium.

57. The method according to claim 48, wherein the housing is equipped with a heater.

58. The method according to claim 57, wherein the housing has a cover with an opening for the supply of the gaseous medium, a bottom with an opening for the discharge of the gaseous medium, and a side wall with a heater installed on it.

59. The method according to claim 48, wherein the supply pipeline is equipped with a heater.

60. The method according to claim 48, wherein the gaseous medium includes inert gas.

61. The method according to claim 48, further comprising the step of:
providing a chiller and a condenser;
wherein the hydrogen igniter housing is connected to the chiller by the outgoing pipeline providing removal of the gaseous medium from the gaseous medium removal orifice to the chiller and condenser.

62. The method according to claim 48, wherein the shutoff valves are installed on the outgoing pipeline providing control of gaseous medium removal.
